(19) United States
(12) Patent Application Publication
(10) Pub. No.: US 2025/0149670 A1
(43) Pub. Date: May 8, 2025

(54) BATTERY PACKS FOR ELECTRIC VEHICLES

(71) Applicant: Telo Trucks Inc., San Francisco, CA (US)

(72) Inventors: David Osman DOLUCA, Saratoga, CA (US); Forrest Jean NORTH, Redwood City, CA (US)

(21) Appl. No.: 18/942,156

(22) Filed: Nov. 8, 2024

Related U.S. Application Data
(60) Provisional application No. 63/597,242, filed on Nov. 8, 2023.

(51) Int. Cl. H01M 10/625; B60K 1/04; B60L 50/60; B60L 50/64; B60N 2/005; B62D 25/16; H01M 10/0525; H01M 10/613; H01M 10/643; H01M 10/6551; H01M 10/6569; H01M 50/213; H01M 50/222; H01M 50/249; H01M 50/258

(52) U.S. Cl. CPC H01M 10/625; B60K 1/04; B60L 50/64; B60L 50/66; B60N 2/005; B62D 25/16; H01M 10/0525; H01M 10/613; H01M 10/643; H01M 10/6551; H01M 10/6569; H01M 50/213; H01M 50/222; H01M 50/249; H01M 50/258; B60K 2001/0438; H01M 2220/20

(57) ABSTRACT

A flat battery pack that includes a cooling system is described. The cooling system, in some embodiments, includes a cooling assembly and heat exchange assembly that function to remove heat from the battery pack via cooling, such as cooling due to water or another coolant flowing through multiple cooling channels of the battery pack. The cooling system may be configured and/or adapted to accommodate placement of the flat battery pack in a chassis or frame of an electric truck, such that the flat battery pack is partially integrated into the chassis/frame while being cooled during operation.

### OVERVIEW

This application claims priority to U.S. Provisional Patent Application No. 63/597,242, filed on Nov. 8, 2023, entitled BATTERY PACKS FOR ELECTRIC VEHICLES, which is hereby incorporated by reference in its entirety.

### OVERVIEW

An electric vehicle (EV) utilizes an electric motor for propulsion. There are many types of EVs, including electric cars and trucks, electric trains, electric bicycles and other micro-mobility devices (e.g., scooters, skateboards, and so on), electric boats, electric aircraft, electric spacecraft, and others.

Electric trucks can be particularly useful to people, as they combine the benefits of an electric vehicle (low or zero emissions, low noise) with the utility of a truck (hauling, storage, power, and so on). However, current electric trucks are often simple electric versions of gas-powered trucks, and thus can suffer from drawbacks (e.g., too large for cities or other dense areas) that deter adoption by users.

### BRIEF DESCRIPTION OF THE DRAWINGS

Embodiments of the present technology will be described and explained through the use of the accompanying drawings.

FIG. 1 is a diagram illustrating an example electric truck.

FIGS. 2A-2D are diagrams illustrating a platform for an electric truck.

FIG. 3 is a diagram illustrating a battery pack for an electric truck.

FIG. 4 is diagram illustrating a battery module of a battery pack or battery package.

FIG. 5 is diagram illustrating a half battery pack and associated cooling system.

FIGS. 6A-6C are diagrams illustrating a cooling system.

FIGS. 7A-7D are diagrams illustrating a cooling assembly.

FIGS. 8A-8C are diagrams illustrating a heat exchange assembly.

FIGS. 9A-9B are diagrams illustrating a heat pipe.

In the drawings, some components are not drawn to scale, and some components and/or operations can be separated into different blocks or combined into a single block for discussion of some of the implementations of the present technology. Moreover, while the technology is amenable to various modifications and alternative forms, specific implementations have been shown by way of example in the drawings and are described in detail below. The intention, however, is not to limit the technology to the particular implementations described. On the contrary, the technology is intended to cover all modifications, equivalents, and alternatives falling within the scope of the technology as defined by the appended claims.

### DETAILED DESCRIPTION

### Overview

Various systems and methods associated with an electric battery, or battery pack, for an electric vehicle are described. In some embodiments, an electric truck may include a flat battery pack, such as a battery pack that includes multiple battery pack modules disposed in a flat configuration (e.g., a single layer of battery pack modules).

The flat battery pack, in some cases, includes a cooling system, having a cooling assembly and heat exchange assembly, which removes heat from the battery pack via cooling, such as cooling due to water or a coolant flowing through multiple cooling channels of the battery pack. The cooling system may be configured and/or adapted to accommodate placement of the flat battery pack in a chassis or frame of an electric truck, such that the flat battery pack is partially integrated into the chassis/frame and is cooled during operation.

Thus, an electric vehicle, such as the electric truck, can include a flat battery pack and associated cooling system adapted for the battery pack and/or integration with the platform of the electric truck, providing for enhanced or improved cooling of a battery pack that is flat and/or disposed within an area of the EV that is compact in size or cannot accommodate conventional heat sinks or other cooling systems, among other benefits.

While described herein with respect to electric trucks, in some embodiments aspects of the technology described herein can be configured or utilized with other electric vehicles or electric devices, such as electric cars, wheeled micro-mobility vehicles, and so on.

Various embodiments of the technology will now be described. The following description provides specific details for a thorough understanding and an enabling description of these embodiments. One skilled in the art will understand, however, that these embodiments may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments.

### Examples of an Electric Truck

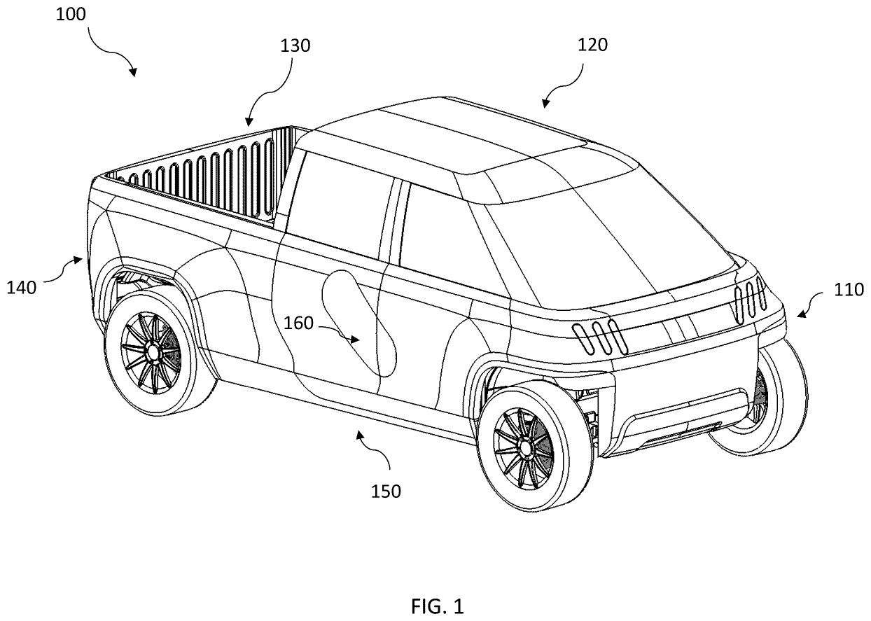

As described herein, an electric truck (or other type of EV) and associated battery pack, is described. FIG. 1 is a diagram illustrating an example electric truck 100. The electric truck 100 includes a front area 110 or subframe, which contains an electric drivetrain or motor driven by an electric battery. The electric truck 100 also includes a cab 120 (e.g., a four-door cab), a truck bed 130 (e.g., which can be configurable and/or capped), a rear area 140, which can also include components of an electric drivetrain or motor, and a frame, chassis, or platform 150 upon which the cab 120 and various components of the electric truck 100 are disposed (e.g., a flat electric battery).

As described herein, the electric truck 100 can have a length that is typical of most cars, such as a length of 13-14 feet. As shown, the front area 110 of the electric truck 100 does not add additional length to the truck, because the drivetrain, battery pack, and other components are disposed at other locations within the truck (e.g., within the frame of the platform 150) or are located under a footwell of the front area 110.

In some embodiments, the cab 120 of the electric truck 100 includes vents 160 or air flow openings, which assist in the flow of air from the front area 110 of the electric truck 100 to the rear of the truck and out of the vents 160. For example, as described herein, the vents 160 are positioned at a height that facilitates the flow of air through open wheel wells of the front area 110 of the electric truck 100 and out of the vents 160 on the side of the cab 120 of the electric truck 100. Additional details regarding suitable electric trucks or EVs may be found in U.S. patent application Ser. No. 18/741,608, filed on Jun. 12, 2024, entitled ELECTRIC TRUCKS AND ASSOCIATED SYSTEMS, which is incorporated by reference in its entirety.

In various embodiments, aspects of the electric truck 100 may include components and/or modules implemented with a combination of software (e.g., executable instructions, or computer code) and hardware (e.g., at least a memory and processor). Accordingly, as used herein, in some example embodiments, a component/module is a processor-implemented component/module and represents a computing device having a processor that is at least temporarily configured and/or programmed by executable instructions stored in memory to perform one or more of the functions that are described herein.

For example, the electric truck 100 includes computing system that implements a controller area network, or CAN (CAN-HS), or CAN bus, which facilitates communications between various devices or systems, such as Electronic Control Units (ECUs). ECUs may communicate via the CAN or a similar protocol, such as LIN, FlexRay, an automotive ethernet, and so on. Further, the various devices can utilize 1000Base-T1 communications, GMSL or FPD-Links (e.g., versions of MIPI CSI-2), DSI, and so on. The CAN may also support communications with other components, such as an electric motor, a battery pack or battery modules (via a BMS, or battery management system), a wireless network (e.g., the Internet) and so on.

In some embodiments, the systems, methods, and techniques introduced here can be implemented as special-purpose hardware (for example, circuitry), as programmable circuitry appropriately programmed with software and/or firmware, or as a combination of special-purpose and programmable circuitry. Hence, implementations can include a machine-readable medium having stored thereon instructions which can be used to program a computer (or other electronic devices), such as the CAN, to perform a process. The machine-readable medium can include, but is not limited to, floppy diskettes, optical discs, compact disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other types of media/machine-readable medium suitable for storing electronic instructions.

The network can be any network, ranging from a wired, or wireless local area network (LAN), to a wired or wireless wide area network (WAN), to the Internet or some other public or private network, to a cellular (e.g., 4G, LTE, 5G, 6G, and so on), and so on. While connections between the various devices and the network may be separate connections, these connections can be any kind of local, wide area, wired, or wireless network, public or private.

Further, any or all components depicted in the Figures described herein can be supported and/or implemented via one or more computing systems or servers. Although not required, aspects of the various components or systems are described in the general context of computer-executable instructions, such as routines executed by a general-purpose computer, e.g., mobile device, a server or cloud-based computer, or personal computer. The system can be practiced with other communications, data processing, or computer system configurations, including: Internet appliances, hand-held devices (including tablet computers and/or personal digital assistants (PDAs)), all manner of cellular or mobile phones, multi-processor systems, microprocessor-based or programmable consumer electronics, set-top boxes, network PCs, mini-computers, mainframe computers, AR/VR devices, and the like. Indeed, the terms “computer,” “host,” and “host computer,” and “mobile device” and “handset” are generally used interchangeably herein and refer to any of the above devices and systems, as well as any data processor.

Aspects of the system can be embodied in a special purpose computing device or data processor that is specifically programmed, configured, or constructed to perform one or more of the computer-executable instructions explained in detail herein. Aspects of the system may also be practiced in distributed computing environments where tasks or modules are performed by remote processing devices, which are linked through a communications network, such as a Local Area Network (LAN), Wide Area Network (WAN), or the Internet. In a distributed computing environment, program modules may be located in both local and remote memory storage devices.

### Examples of a Platform for an Electric Truck

As described herein, in some embodiments, the electric truck 100 includes or is supported by a platform, such as a “skateboard” style platform or chassis, which supports various structures, loads, and/or areas of the electric truck. The platform can facilitate the configuration or use of different truck modules or components, enabling the truck to provide the functionality of a truck (e.g., a bed for hauling objects, power to tow objects) while maintaining a length that is comparable to a car (e.g., 13-14 feet in length). In some embodiments, a flat battery pack is disposed or integrated (e.g., partially) within the platform.

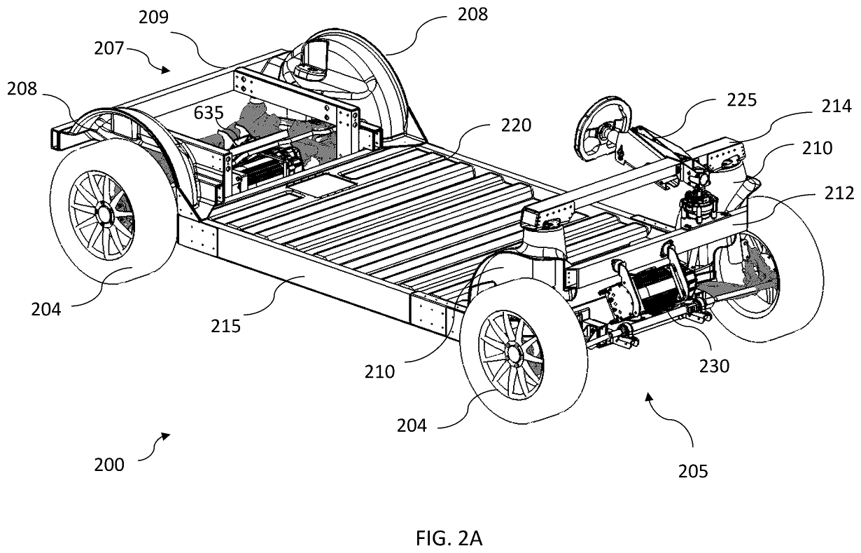

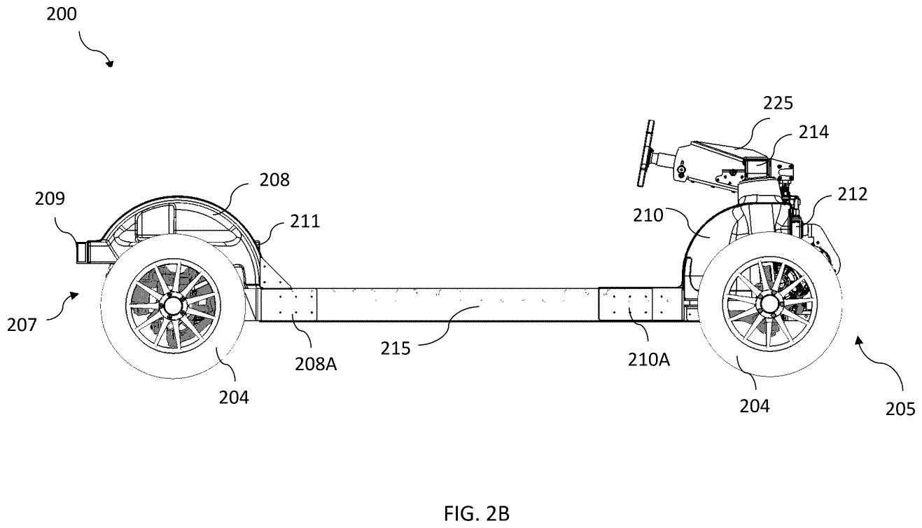

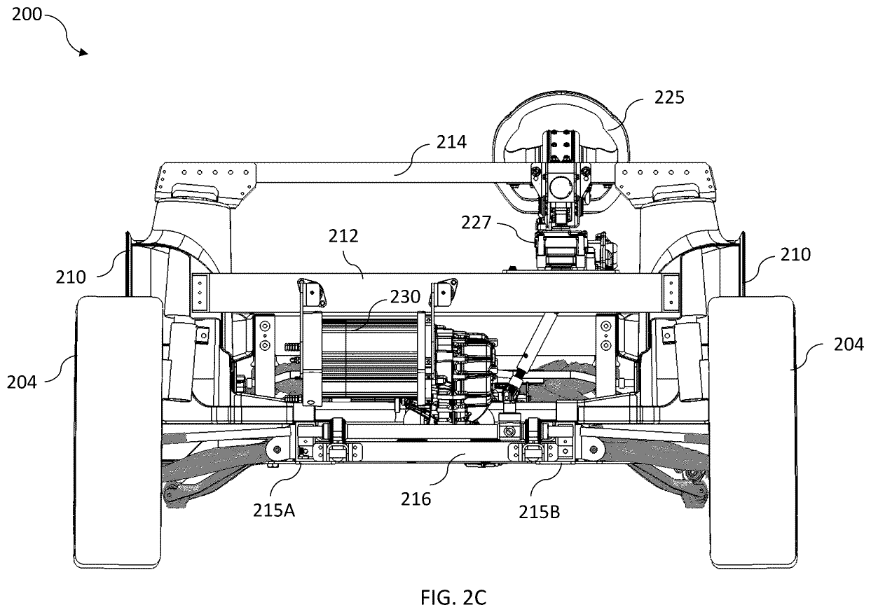

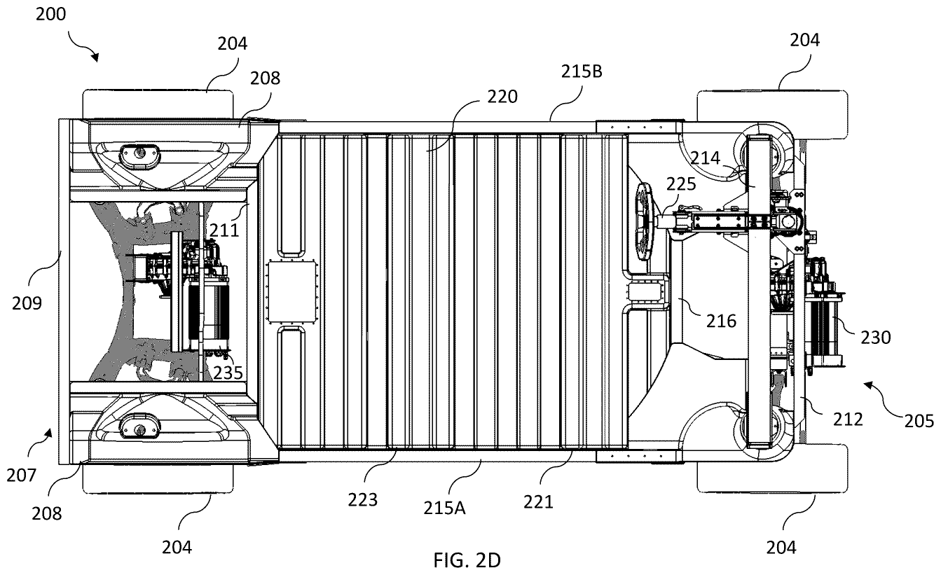

FIGS. 2A-2D are diagrams illustrating a platform 200 for an electric truck, such as the electric truck 100. The platform, in some embodiments, includes a quarter monocoque construction, where the chassis of the truck is at least partially integrated with the body of the truck. For example, as depicted, the platform 200 includes four composite wheel wells (e.g., two front wheel wells 210 and two rear wheel wells 208) connected to straight frame extrusions 215 (e.g., aluminum extrusions). Thus, in some cases, the platform 200 provides a modular structure or chassis for an electric truck.

The front wheel wells 210, located at a front area 205 of the platform 200, are a rigid structural element of the platform 200 (and, thus, the truck or vehicle that is supported by the platform 200). The front wheel wells 210 include wheels 204 and connect the frame, a front subframe, a footwell, a top of a MacPherson strut, an A-Pillar, front crash safety components, a front bumper, and/or a body of the truck or vehicle. The front wheel wells 210 can be optimized or configured for vehicle ingress and egress, such as by adhering to an exterior perimeter of tire motion (with space for debris) and for providing footwell horizontal space for passengers.

The front area 205 includes a first front straight frame extrusion 214 that connects a top portion of a right front wheel well 210 to a top portion of a left front wheel well 210 and a second front straight frame extrusion 212 that connects a lower portion of the right front wheel well 210 to a lower portion of the left front wheel well 210. The front area 205 also includes a third front straight frame extrusion 216 that connects a front portion 215A of the right straight frame extrusion 215 to a front portion 215B of the left straight frame extrusion 215.

A steering assembly 225 is disposed and/or mounted to the first front straight frame extrusion 214 and may include various power steering components 227. Further, a motor package 230 is disposed and/or mounted below the second front straight frame extrusion 212.

Similarly, the rear wheel wells 208, located at a rear area 207 of the platform 200, are a rigid structural element of the platform 200 (and, thus, the truck or vehicle that is supported by the platform 200). The rear wheel wells 208 include wheels 204 and connect the frame, a rear subframe, a top of a rear strut (in a multilink or 4-bar suspension), a rear bumper, bed mounts, and/or body mounts of the truck. The rear wheel wells 208 can be optimized or configured for maximum bed space and can include an internal or hidden (locked) luggage or storage compartment.

The rear area 207 includes a first rear straight frame extrusion 209 that connects a rear portion of a right rear wheel well 208 to a rear portion of a left rear wheel well 208 and a second rear straight frame extrusion 211 that connects an inner portion of the right rear wheel well 208 to an inner portion of the left rear wheel well 208. A rear motor package 235 may be disposed or located between the rear wheel wells 208 and the rear straight frame extrusions 209, 211.

In some embodiments, the wheel wells (e.g., front wheel wells 210 and/or rear wheel wells 208) may be formed of structural carbon or similar composite, while the frame extrusions are formed of aluminum or other similar metals. However, aspects of the wheel wells or extrusions may also be formed of structural carbon, such as interface sections 608A, 610A, which connect, couple, and/or interface between the wheel wells and the frame extrusions.

A battery package 220, such as a flat electric battery, battery pack, or battery assembly, as described herein, may be disposed and/or mounted within the platform 200, such as between the wheel wells and the frame extrusions. The battery package 220 may include mount structures 221, 223, which facilitate the mounting of seats (e.g., rear seats and front seats) to the platform 200. Thus, the battery package 220 may fit within the platform 200 such that a top surface of the battery package 220 does not extend above the frame extrusions, providing a surface for mounting seats or other internal components of an electric truck (e.g., with battery cells located on a bottom surface of the platform, as is described herein). In some cases, the battery package 220 may include a cooling assembly or cooling plate located on an underside or lower area of the platform 200. Further details are described herein.

Thus, in some embodiments, the platform 200 may facilitate the mounting of the front motor package 230 disposed below the front straight frame extrusion of the front area (e.g., the second front straight frame extrusion 212), the rear motor package 235 disposed between the two rear wheel wells 208 of the rear area 207, and electric battery or battery package 220 disposed between right and left straight frame extrusions 215A, 215B of the platform 200. The platform 200, therefore, may enable or provide powertrain packages in a front and/or rear area of the electric truck, facilitating a larger bed geometry (e.g., a 49-inch-wide bed at its narrowest), as well as a shorter front area, among other benefits.

### Examples of a Battery Pack

As described herein, a battery package or battery pack, such as the battery package 220, may have a flat configuration, wherein individual battery modules are disposed or positioned next to one another on a same horizontal plane or orientation.

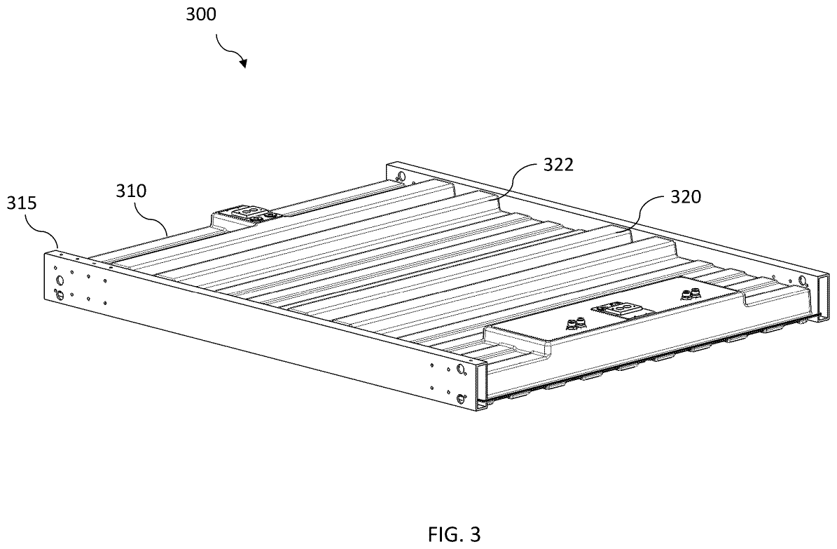

FIG. 3 is a diagram illustrating a battery pack 300 for an electric truck or other EV, such as the electric truck 100. The battery pack 300, which may be the battery package 220, may be a flat, space efficient, battery package, providing, for example, 300-400 Wh/L, or greater, of power to the EV. In some embodiments, the battery pack 300 is a Vertical Height Optimized Battery Pack (VHO Battery Pack), which utilizes a high conductance material (e.g., a CelLink material) to act as a current collector, bus bars, data lines, and battery management system (BMS) lines for a BMS of the battery pack 300.

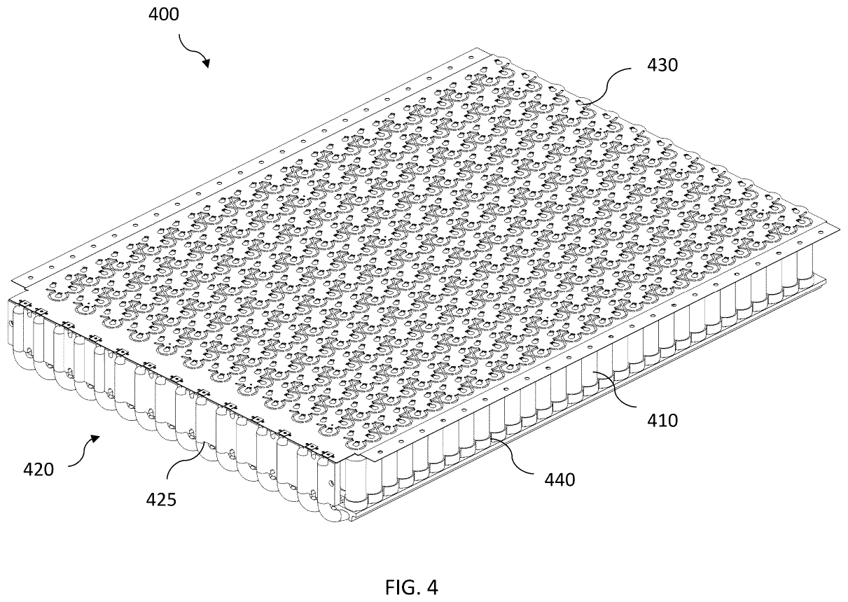

The battery pack 300 may include multiple battery modules, such as eight battery modules, as described herein. In some cases, the multiple battery modules are part of a cell assembly. FIG. 4 is a diagram illustrating an example battery module 400. The battery module 400 may include multiple battery cells 410, a cooling assembly 420 (or cooling plate) disposed below the battery cells 410, and a conductive layer 430 disposed as a top layer, such as a stamped interconnect, conductor, or conductive layer, which connects the battery cells 410 to one another.

The battery cells 410, in some cases, are cylindrical Lithium Ion (Li-Ion) cells, grouped into the battery module 400. The battery cells 410 can have different sizes, such as 18650 cells, 4680 cells, 21700 cells, and so on. A support structure or holder 440, such as a holder that disposes the battery cells 410 in a vertical orientation, is configured to position the battery cells 410 within the battery module 400.

In some cases, the battery module 400 includes the cooling assembly 420 to extract heat out of the battery cells 410. The cooling assembly 420 may be part of a cooling system that operates to cool or otherwise remove heat from the battery pack 300 (or a portion of the battery pack 300, such as a half of the battery pack 300). The cooling assembly 420 may include heat pipes 425, positioned under the battery cells 410, which move heat away from the battery cells 410 and to a cooling manifold. As described herein, the cooling manifold, which may be placed proximate to multiple battery cells 400, may include thin, flat (<1 cm thick) channels that facilitate the flow of coolant proximate to the heat pipes 425 of the battery modules 400.

In some cases, the battery pack 300 and/or battery modules 400 may also include electrically insulative, thermally conductive material between the bottom of the battery cells 410 and the cooling assembly 420. The material may be formed of a thermal Sil Pad material, thermal epoxy, and so on, and facilitate an optimized cell packaging (e.g., 1 mm air gaps between cells), or layout of the battery cells 410. Further, the battery pack 300 and/or battery modules 400 include a main board or controller and on ore more BMSs.

Returning back to FIG. 3, a top surface 310 of the battery pack 300 may include seat mounts 320, 322, or other mounting components, and have a structure that includes frame extrusions 315 and/or can be coupled or connected to the frame extrusions of the platform 200 of the electric truck 100, as described herein. For example, the top surface 310 of the battery pack 300 may include a carbon fiber clamshell (e.g., two pieces), which can provide a rigid housing, space for battery expansion, space for collision protection, where the clamshell has integrated seat, floor, and bed mounts. The bottom of the clamshell may be aerodynamically efficient and mount a skid plate flush to its topology.

In some embodiments, the battery pack 300 is laser welded to a single side, which leaves the bottom free for cooling, adding, for example, 1 mm of extra vertical height to the overall battery height. For example, using the Cell Link created material, the battery pack 300 may individually fuse each battery cell (e.g., the battery cells 410), which are disposed on a bottom surface of the battery pack 300. In some cases, the battery pack 300 can be manufactured using a jig or similar structure, which can provide efficiencies in manufacturing (e.g., the pack is manufactured in its enclosure). For additional details, see U.S. patent application Ser. No. 17/542,190, filed on Dec. 3, 2021, entitled MANUFACTURING A BATTERY PACK USING A WELDING JIG, which is hereby incorporated by reference in its entirety.

Thus, the battery pack 300 may include multiple battery modules 400 (e.g., eight) positioned in a flat or horizontal orientation. In one configuration, the total height of the battery pack 300 is 81.7 mm, and in various configurations, the height of the battery pack 300 is between 80-90 mm. In some cases, the battery pack 300 may include fewer (e.g., six) or more (e.g., ten or more) battery modules 400.

As described herein, the battery pack 300 may include a cooling system that is configured to cool the battery pack 300 during operation (e.g., when the electric truck 100 is being driven). The cooling system may be deployed for the entire battery pack 300 (e.g., all eight battery modules 400), for half of the battery pack 300 (e.g., a front or rear section of four battery modules 400), and so on. The cooling system, in various embodiments, includes a cooling assembly and a heat exchange assembly. The cooling assembly moves coolant (e.g., water, a water-based mixture (e.g., a water/ethylene glycol mixture or a water/propylene glycol mixture), and so on) to heat pipes of the heat exchange assembly, which causes an exchange of heat from the battery cells 410 of the various battery modules 400 to the coolant of the cooling assembly.

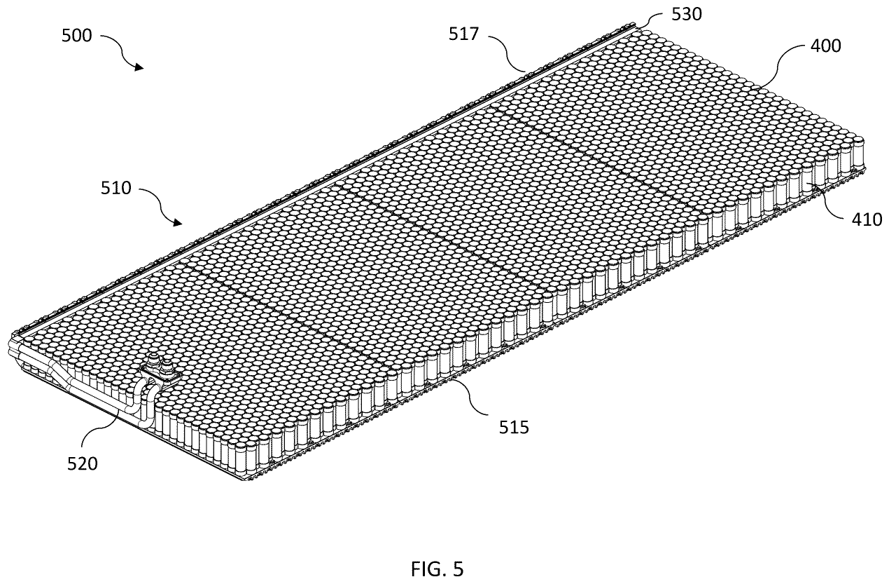

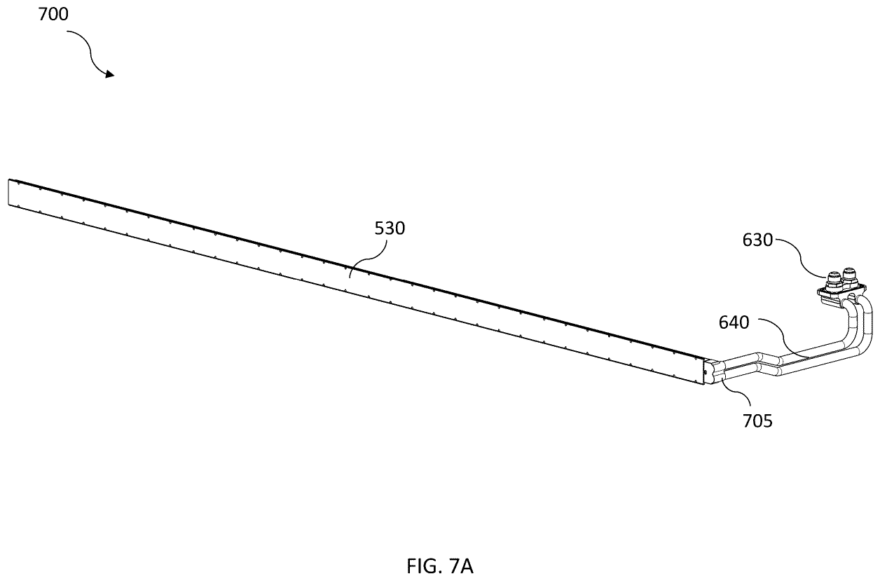

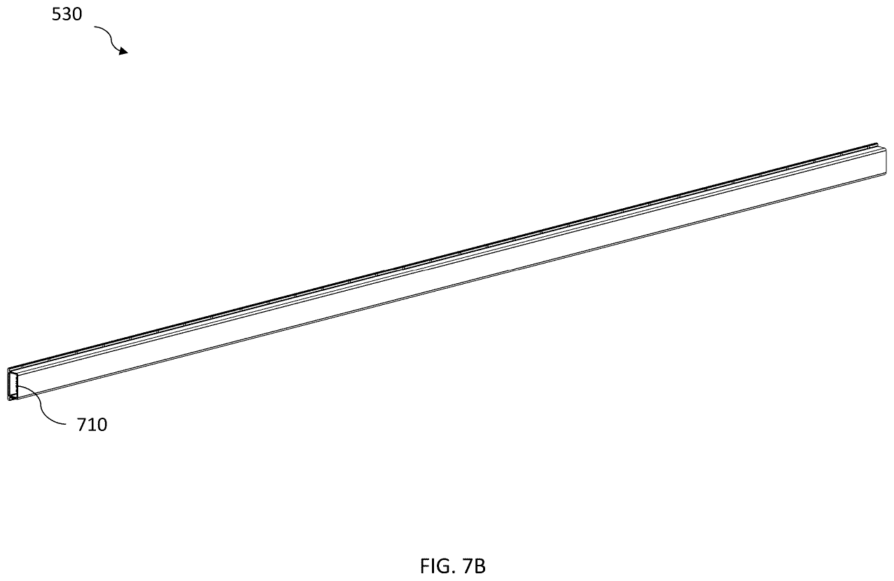

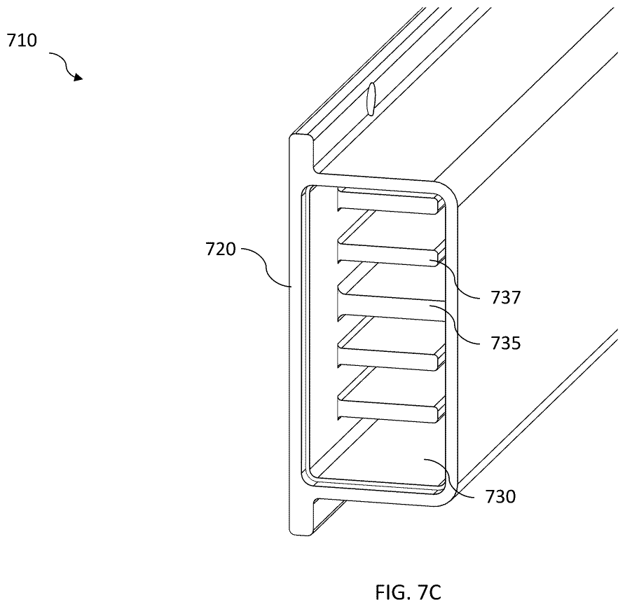

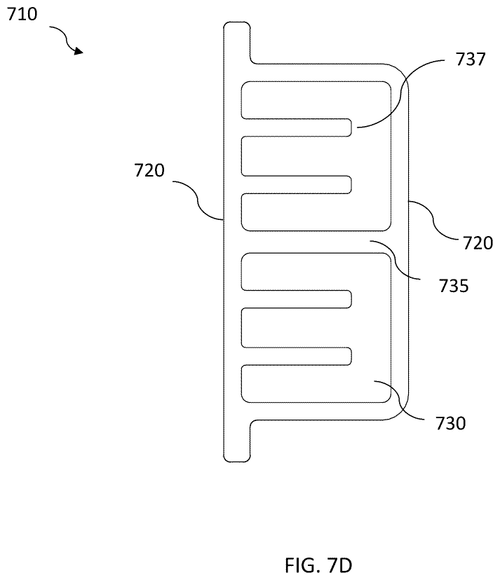

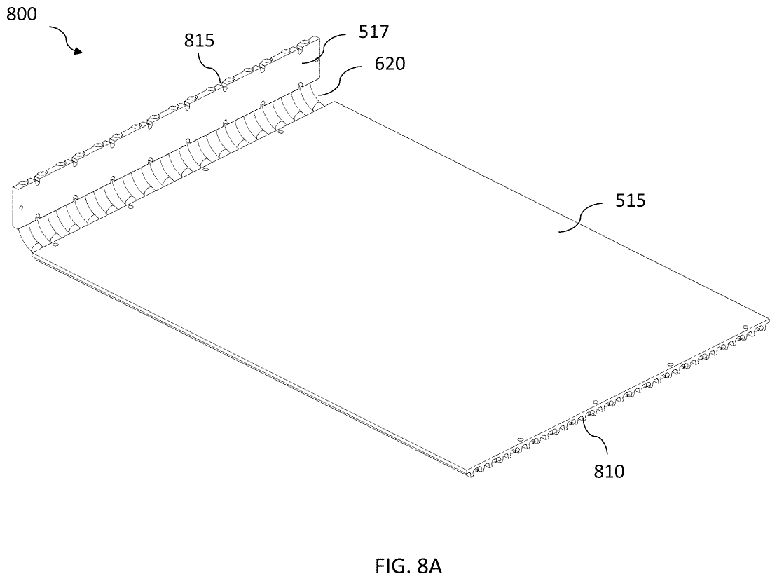

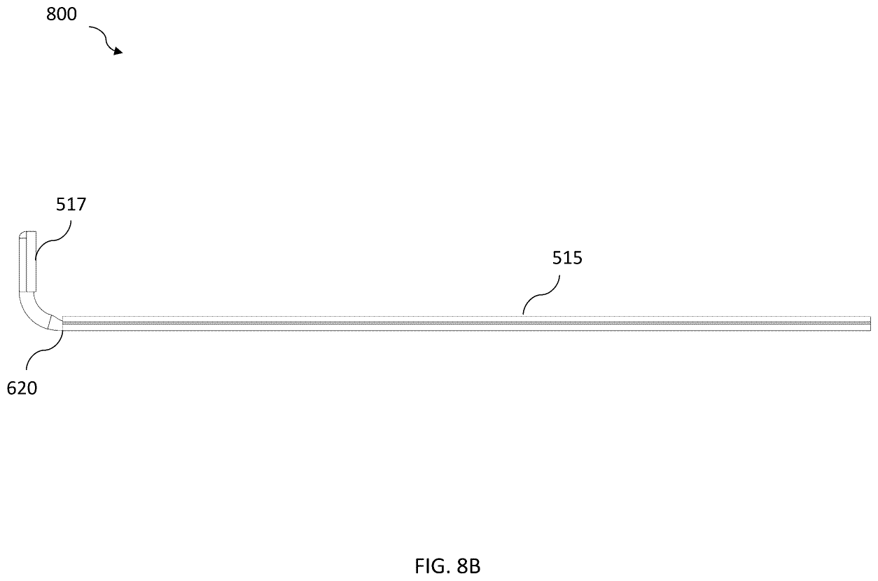

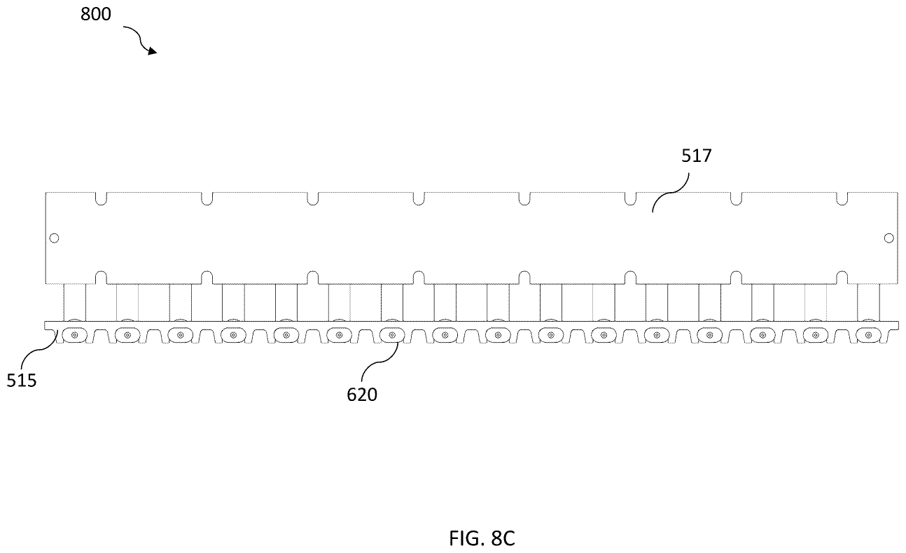

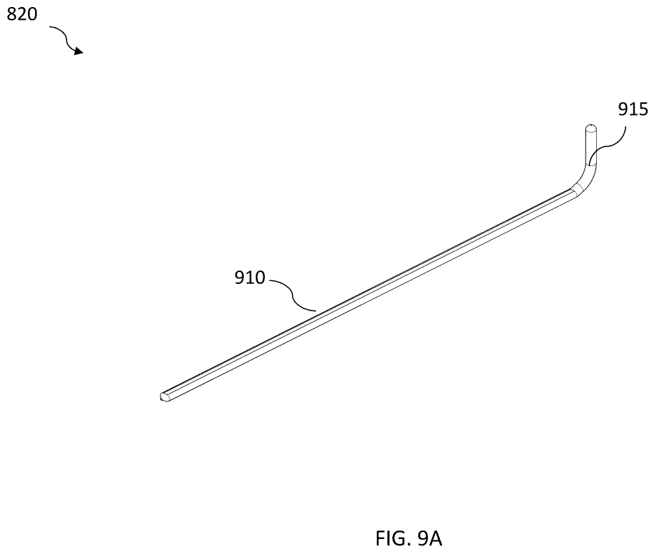

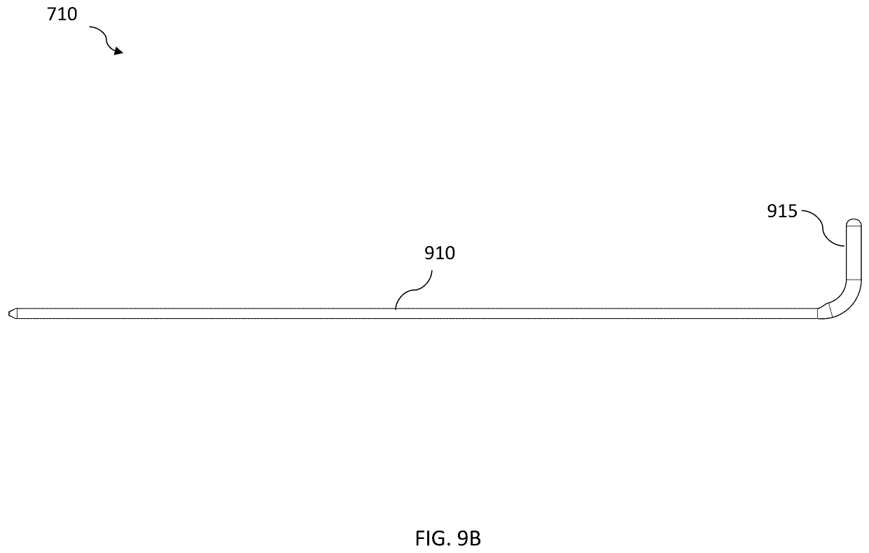

FIG. 5 is diagram illustrating a half battery pack 500 and associated cooling system 510. The half pack 500 includes four battery modules 400 (e.g., a cell assembly), which contain battery cells 410 in a vertical orientation, as described herein. The coolant system includes a cooling assembly (shown in more detail in FIGS. 7A-7D) together with a heat exchange assembly (shown in more detail in FIGS. 8A-9B).

For example, the heat exchange assembly includes an evaporator plate 515 positioned or disposed below the multiple cells 410 (e.g., a cell assembly) of the battery modules 400, and a condenser plate 517 positioned or disposed proximate to (or in contact with) a manifold 530 of the cooling assembly. As shown, the evaporator plate 515 of the exchange assembly is partially disposed below the multiple battery modules 400 and configured to transfer heat out of a lower area of the cell assembly (e.g., below the multiple battery modules 400), and the cooling assembly, via the manifold 530, is coupled with the heat exchange assembly, via the condenser plate 517, at an outer edge location of the cell assembly.

The cooling assembly includes a coolant assembly 520, which transfers coolant from an intake component and into various channels of the manifold 530. Thus, the coolant, flowing within the manifold 530, cools or mitigates the heat that has been transferred or otherwise exchanged out from an underside of the half battery pack 500 (via heat pipes that connect between the evaporator plate 515 and the condenser plate 517, as described herein).

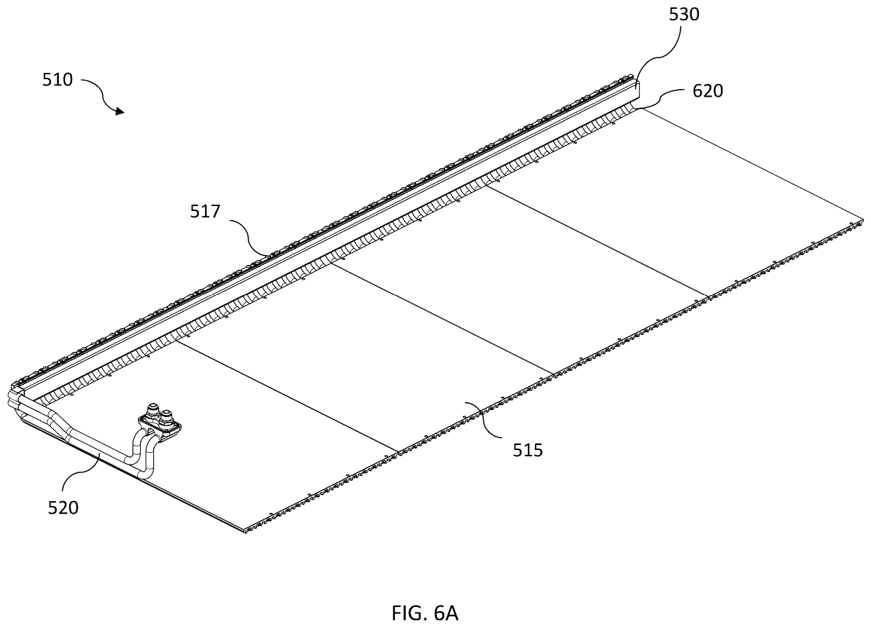

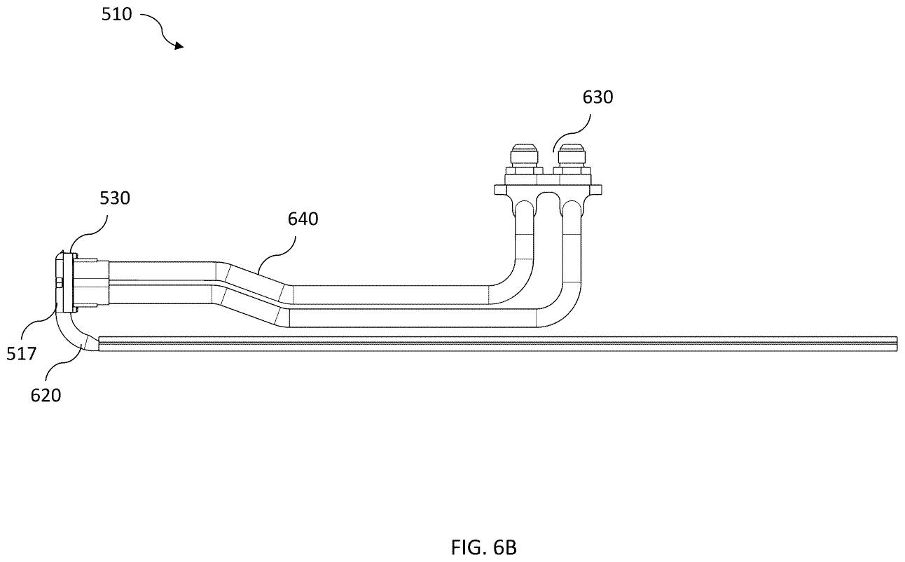

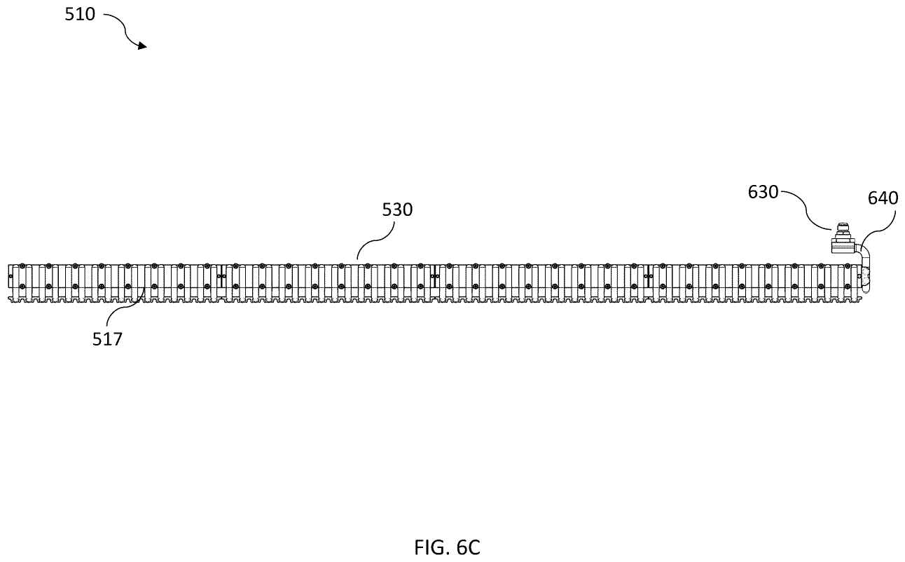

FIGS. 6A-6C depict additional aspects of the cooling system 510. The coolant assembly 520 includes coolant tubes 640, which are disposed on an outer side of the battery pack 400 and function to transfer coolant from an intake component 630, which is positioned above the battery pack 400, to the manifold 530.

The heat exchange assembly includes a heat pipe 620, as described herein, which couple the evaporator plate 515 to the condenser plate 517. For example, the heat pipes 620 may run in a horizontal orientation along a bottom area of the evaporator plate 515, and then turn and run in a vertical orientation along the condenser plate 517, which contacts the manifold 530 of the cooling assembly. Thus, the heat exchange assembly is configured to move heat in one direction (e.g., a horizontal direction) to an outer edge or area of the half battery pack 500 and provide the heat for cooling in a different direction (e.g., a vertical direction).

As shown, the cooling assembly may include a separate evaporator plate 515 and condenser plate 517 for each battery module 400, along with a sufficient number of heat pipes 620 (e.g., ten to twenty) for transferring heat away from the battery cells 410 of the battery modules 400. Of course, in some cases, the heat exchange assembly may include fewer evaporator plates 515 and/or condenser plates 517 (e.g., one for every two battery modules 400) or more evaporator plates 515 and/or condenser plates 517.

FIG. 7A depicts an example cooling assembly 700. As described herein, the cooling assembly 700 includes the manifold 530, the coolant tubes 640, the intake component 630, and a plug 705 that connects the coolant tubes 640 to the manifold 530. The plug may include barbs and an O-ring to facilitate secure coupling with the manifold 530. The coolant tubes 640 may be aluminum tubes bent to position within the chassis of the electric truck 100, providing a conduit or transfer of coolant from the intake component 630 to the manifold 530. The intake component 630 may include or support an AN fitting when coupled with the coolant tubes 640.

FIGS. 7B-7D depict additional details of the manifold 530, such as an inner area 710 of the manifold 530 through which the coolant flows or travels. The inner area 710 may be configured to facilitate or cause a bi-directional flow of the coolant through the manifold 530, such that an outer surface 720 of the manifold 530 that is proximate to (e.g., makes contact with) the condenser plate 517 may cool the condenser plate 517 via the flow of coolant in one direction and move warmer coolant out of the inner area 710 in the other direction.

For example, the inner area 710 may include multiple channels 730, separated by an inner rib boundary 735, which enables the bi-directional flow of the coolant (e.g., initially through an upper channel and out (when warm or heated) via a lower channel, or vice versa). The channels 730, in some cases, may include fins 737, which can assist in the exchange of heat from the condenser plate 517 and into the coolant, and/or assist in the flow of coolant within the channels 730.

FIGS. 8A-8C depict an example heat exchange assembly 800. As described herein, the heat exchange assembly 800 includes the evaporator plate 515 (e.g., an extrusion), the condenser plate 517 (e.g., an extrusion), and multiple heat pipes. In some cases, the evaporator plate 515 includes a profile (e.g., shape, pattern, or geometry) 810 that facilitates coupling or positioning of the heat pipes 620 under the evaporator plate 515 (e.g., in a horizonal orientation). Further, in some cases, the condenser plate 517 includes a profile (e.g., shape, pattern, or geometry) 815 that facilitates coupling or positioning of the heat pipes 620 next to the condenser plate 517 (e.g., in a vertical orientation).

Also, given the position of the condenser plate 517 being higher than the evaporator plate 515, the heat exchange assembly 800 utilize the forces of gravity to assist in cooling the battery pack 300 (e.g., providing a higher heat exchange rate).

In some embodiments, the heat pipes 620 may operate in a bi-directional manner, where the heat exchange assembly 800 heats the cell assembly and/or one or more of the battery pack modules 400. For example, during a heating operation, the evaporator plate 515 may function as a condenser, and the condenser plate 517 may function as an evaporator, enabling the heat exchange assembly to move or transfer heat into the battery pack 300.

FIGS. 9A-9B depict the heat pipe 820, which, in some cases, is a tubular vapor chamber. The heat pipe 820 includes a horizontal component 910 and a vertical component 915. Each component may have a different shape or geometry, such as a certain cross-sectional shape or geometry. For example, the horizontal component 910 may be shaped in a ovular or relatively flat manner, such as to facilitate the transfer of heat from the evaporator plate 515, where the vertical component 915 has a circular shape or geometry for ease of manufacturing or positioning with respect to the condenser plate 517

Thus, in various embodiments described herein, an electric vehicle, such as the electric truck 100, can include a flat battery pack, such as the battery pack 300 and associated cooling system adapted for the battery pack 300 and/or integration with the platform 200 of the electric truck 100. By use of such a pack, the electric vehicle can have a smaller overall size without sacrificing power or energy storage capabilities, among other benefits.

### Example Embodiments of the Disclosed Technology

The electric truck, cooling system, battery packs, and various systems and methods described herein may be implemented as follows.

In some embodiments, a battery pack for an electric vehicle may include multiple battery modules, wherein each battery module includes multiple battery cells disposed in a vertical orientation, and a conductive layer disposed on top of the multiple battery cells that connects the multiple battery cells, and a cooling system disposed at least partially below the multiple battery modules that is configured to cool the multiple battery cells of the multiple battery modules.

In some cases, the cooling system includes a heat exchange assembly at least partially disposed below the multiple battery modules and configured to transfer heat out of a lower area of the multiple battery modules, and a cooling assembly that is coupled with the heat exchange assembly at an outer edge location of the multiple battery modules.

In some cases, the heat exchange assembly includes an evaporator plate positioned in a horizontal orientation and disposed below the multiple battery modules, a condenser plate positioned in a vertical orientation and disposed at the outer edge location of the multiple battery modules, and multiple heat pipes that couple the evaporator plate to the condenser plate.

In some cases, each heat pipe of the multiple heat pipes includes a horizontal component that contacts the evaporator plate and a vertical component that contacts the condenser plate.

In some cases, the cooling assembly includes a manifold that is disposed at the outer edge location of the multiple battery modules and includes an inner area having bi-directional channels through which coolant flows through the manifold.

In some cases, the cooling assembly includes an intake component disposed on a top area of an outer battery module of the multiple battery modules and one or more coolant tubes that couple the intake component to the manifold.

In some cases, the cooling assembly includes a plug that couples the one or more coolant tubes to the manifold.

In some cases, the manifold is positioned proximate to all battery modules of the multiple battery modules of the battery pack.

In some cases, each channel of the bi-directional channels includes a cooling fin.

In some cases, the multiple battery cells comprise Lithium Ion (Li-Ion) 18650 cells.

In some cases, the battery pack includes a housing that contains the multiple battery modules and has a two-piece carbon fiber clamshell configuration.

In some cases, the housing comprises a top surface that includes one or more seat mounts configured to mount seats of an electric vehicle.

In some cases, the housing comprises a structure configured to mount to frame extrusions of a platform of an electric vehicle.

In some cases, a total height of the housing is between 80 and 90 millimeters.

In some embodiments, a battery pack may include a cell assembly that includes multiple battery modules, a heat exchange assembly at least partially disposed below the multiple battery modules and configured to transfer heat out of a lower area of the cell assembly, and a cooling assembly that is coupled with the heat exchange assembly at an outer edge location of the cell assembly.

In some cases, each multiple battery module of the multiple battery modules includes multiple battery cells disposed in a vertical orientation, a holder that positions the multiple battery cells in the vertical orientation, and a conductive layer disposed on top of the multiple battery cells that connects the multiple battery cells.

In some cases, the heat exchange assembly includes an evaporator plate positioned in a horizontal orientation and disposed below the cell assembly, a condenser plate positioned in a vertical orientation and disposed at the outer edge location of the cell assembly, and multiple heat pipes that couple the evaporator plate to the condenser plate.

In some cases, the cooling assembly includes a manifold that is disposed at the outer edge location of the cell assembly and includes an inner area having bi-directional channels through which coolant flows through the manifold, an intake component disposed on a top area of an outer battery module of the cell assembly, and one or more coolant tubes that couple the intake component to the manifold.

In some cases, the multiple battery cells comprise Lithium Ion (Li-Ion) 18650 cells.

In some embodiments, an electric truck may comprise a platform, including two front wheel wells connected by at least one front straight frame extrusion, two rear wheel wells connected by at least one rear straight frame extrusion, and right and left straight frame extrusions, a steering assembly that is mounted to the at least one front straight frame extrusions, a motor package that is mounted to the at least one front straight frame extrusion; and an electric battery pack disposed between the right and left straight frame extrusions of the platform, wherein the electric battery pack includes a cell assembly that includes multiple battery modules, a heat exchange assembly at least partially disposed below the multiple battery modules and configured to transfer heat out of a lower area of the cell assembly, and a cooling assembly that is coupled with the heat exchange assembly at an outer edge location of the cell assembly.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or”, in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the electric bike and bike frame may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

From the foregoing, it will be appreciated that specific embodiments have been described herein for purposes of illustration, but that various modifications may be made without deviating from the spirit and scope of the embodiments. Accordingly, the embodiments are not limited except as by the appended claims.

What is claimed is:

1. A battery pack for an electric vehicle, comprising:
multiple battery modules,
wherein each battery module includes:
multiple battery cells disposed in a vertical orientation; and
a conductive layer disposed on top of the multiple battery cells that connects the multiple battery cells; and
a cooling system disposed at least partially below the multiple battery modules that is configured to cool the multiple battery cells of the multiple battery modules.

2. The battery pack of claim 1, wherein the cooling system includes:
a heat exchange assembly at least partially disposed below the multiple battery modules and configured to transfer heat out of a lower area of the multiple battery modules; and
a cooling assembly that is coupled with the heat exchange assembly at an outer edge location of the multiple battery modules.

3. The battery pack of claim 2, wherein the heat exchange assembly includes:
an evaporator plate positioned in a horizontal orientation and disposed below the multiple battery modules;
a condenser plate positioned in a vertical orientation and disposed at the outer edge location of the multiple battery modules; and
multiple heat pipes that couple the evaporator plate to the condenser plate.

4. The battery pack of claim 3, wherein each heat pipe of the multiple heat pipes includes a horizontal component that contacts the evaporator plate and a vertical component that contacts the condenser plate.

5. The battery pack of claim 2, wherein the cooling assembly includes:
a manifold that is disposed at the outer edge location of the multiple battery modules and includes an inner area having bi-directional channels through which coolant flows through the manifold.

6. The battery pack of claim 5, wherein the cooling assembly includes:
an intake component disposed on a top area of an outer battery module of the multiple battery modules; and
one or more coolant tubes that couple the intake component to the manifold.

7. The battery pack of claim 6, wherein the cooling assembly includes:
a plug that couples the one or more coolant tubes to the manifold.

8. The battery pack of claim 5, wherein the manifold is positioned proximate to all battery modules of the multiple battery modules of the battery pack.

9. The battery pack of claim 5, wherein each channel of the bi-directional channels includes a cooling fin.

10. The battery pack of claim 1, wherein the multiple battery cells comprise Lithium Ion (Li-Ion) 18650 cells.

11. The battery pack of claim 1, further comprising:
a housing that contains the multiple battery modules and has a two-piece carbon fiber clamshell configuration.

12. The battery pack of claim 11, wherein the housing comprises a top surface that includes one or more seat mounts configured to mount seats of an electric vehicle.

13. The battery pack of claim 11, wherein the housing comprises a structure configured to mount to frame extrusions of a platform of an electric vehicle.

14. The battery pack of claim 11, wherein a total height of the housing is between 80 and 90 millimeters.

15. A battery pack, comprising:
a cell assembly that includes multiple battery modules;
a heat exchange assembly at least partially disposed below the multiple battery modules and configured to transfer heat out of a lower area of the cell assembly; and
a cooling assembly that is coupled with the heat exchange assembly at an outer edge location of the cell assembly.

16. The battery pack of claim 15, wherein each multiple battery module of the multiple battery modules includes:
multiple battery cells disposed in a vertical orientation;
a holder that positions the multiple battery cells in the vertical orientation; and
a conductive layer disposed on top of the multiple battery cells that connects the multiple battery cells.

17. The battery pack of claim 15, wherein the heat exchange assembly includes:
an evaporator plate positioned in a horizontal orientation and disposed below the cell assembly;
a condenser plate positioned in a vertical orientation and disposed at the outer edge location of the cell assembly; and
multiple heat pipes that couple the evaporator plate to the condenser plate.

18. The battery pack of claim 15, wherein the cooling assembly includes:
a manifold that is disposed at the outer edge location of the cell assembly and includes an inner area having bi-directional channels through which coolant flows through the manifold;
an intake component disposed on a top area of an outer battery module of the cell assembly; and
one or more coolant tubes that couple the intake component to the manifold.

19. The battery pack of claim 15, wherein each multiple battery module of the multiple battery modules includes multiple Lithium Ion (Li-Ion) 18650 cells.

20. An electric truck, comprising:
a platform, including:
two front wheel wells connected by at least one front straight frame extrusion;
two rear wheel wells connected by at least one rear straight frame extrusion; and
right and left straight frame extrusions;
a steering assembly that is mounted to the at least one front straight frame extrusion;
a motor package that is mounted to the at least one front straight frame extrusion; and
an electric battery pack disposed between the right and left straight frame extrusions of the platform, wherein the electric battery pack includes:
a cell assembly that includes multiple battery modules;
a heat exchange assembly at least partially disposed below the multiple battery modules and configured to transfer heat out of a lower area of the cell assembly; and
a cooling assembly that is coupled with the heat exchange assembly at an outer edge location of the cell assembly.
